(19) United States
(12) Patent Application Publication
(10) Pub. No.: US 2013/0154157 A1
(43) Pub. Date: Jun. 20, 2013

(54) NOVEL MATERIAL AND PROCESS OF MANUFACTURE

(71) Applicant: Gary Thompson, Tyne and Wear (GB)

(72) Inventor: Gary Thompson, Tyne and Wear (GB)

(21) Appl. No.: 13/812,748

(22) PCT Filed: Jul. 27, 2011
(86) PCT No.: PCT/GB2011/051431

§ 371 Date: Mar. 11, 2013

(30) Foreign Application Priority Data
Jul. 27, 2010 (GB) 1012554.0

(51) Int. Cl. B29C 43/18

(52) U.S. Cl. CPC B29C 43/18
USPC 264/279.1; 264/319

(57) ABSTRACT

A process for manufacturing a material including glass in particulate form and plastic, comprises the steps of heating the glass in particulate form and/or the plastic to a threshold temperature sufficient to change the state of the plastic from a solid to a viscous liquid, mixing together the glass and plastic to form a mixture, pressing the mixture into a desired shape and curing the pressed mixture.

### FIELD OF THE INVENTION

The invention relates to a novel material; in particular it relates to a process for manufacturing a novel material comprising recycled materials. The invention also relates to products manufactured by the process and a products comprising the material.

### BACKGROUND OF THE INVENTION

Most building materials formed as blocks which are available to the construction industry are based on the 440×215 mm size block with variations in width. The dimensions depend on the final use of the block, which can be for use in foundations, or external or internal walls.

There are a number of available building blocks formed from partially recycled materials. At present, there is no building block on the market that is formed solely from recycled materials. Furthermore, recycled material building blocks usually comprise concrete, cement or aggregate.

Building materials that include recycled materials are more environmentally friendly than conventional bricks and other building materials.

One building block known as the “GeoBrick” is sold by Geofusion. This block is formed from up to 97% recycled materials and includes recycled glass and non-organic binder.

U.S. Pat. No. 5,595,032 describes a glass building block with a hollow glass block having fill holes through which the block is filled with a gel-like product of curing a polydiorganosiloxane composition.

EP1686099 (Zinoviev) relates to the production of construction materials with low eoconductivity and density and to a process of forming block foamed glass processed cullet. The document refers to prior art processes involving melting glass, grinding with a foaming agent, and annealing at a temperature of at least 700° C.

The invention disclosed in the document relates to a feedstock mixture for manufacturing foamed glass, which is a dehydrated composition as a result of physicochemical interaction at a temperature of from 450 to 550° C. of an aqueous alkaline solution of sodium silicate and/or potassium silicate and powdered chemically active additives containing ungraded cullet and a carbonaceous foaming agent.

WO9808896 (Rutgers) describes a composite building material produced from recycled materials. The composite building material is composed of an extruded mixture of high density polyethylene and a thermoplastic coated fibre material such as fibreglass.

JP2005220716 (Wave KK) discloses a permeable concrete block which has layers of crushed stone and recycled glass sand.

It would be desirable to provide an improved material, which advantageously is suitable for use as a building material.

### SUMMARY OF THE INVENTION

The invention provides a process for manufacturing a material as specified in Claim 1. The step of curing in Claim 1 refers to the additional time required post removal from a pressing tool for the whole body of the material to achieve a complete solid state. Obviously the outside of the material will cool more quickly than the inside and therefore will reach this state sooner. Typically a curing time of between 5 and 15 minutes is required, but the actual time required will depend on the nature of the component materials and the dimensions of the resulting material.

The invention also provides a material as specified in Claim 13.

The invention further provides a block comprising the material as specified in Claim 14.

Advantageously, the material is a building material. The material of the invention may be formed inter alia into bricks, blocks, wall boards, scaffold boards, work surfaces, memorial stones and bases.

Advantageously, one of the glass and the plastic is heated to a temperature sufficient to cause the plastic to change from being a solid to become a very viscous liquid. The necessary temperature for a number of different plastics has been established to lie in the range of 230 C and 250 C. Of course other plastics may be developed or become available in recycled form where the threshold temperature for a change of state from solid to viscous liquid is more than 250 C or less than 230 C.

The heated glass or plastic may be mixed with the other of the glass and plastic at room temperature. Alternatively, both the plastic and the glass may be heated prior to mixing thereof. One or both of the glass and plastic may be heated to the required temperature, for example between 230 C and 250 C, prior to mixing thereof.

The duration of heating will depend on the amount of material present and the heat source. What is important is that the whole body of the material is heated to sufficient a temperature to maintain the plastic in its viscous liquid state. Where it is the particulate glass that is heated to require temperature, the plastic when mixed therewith quickly rises to the temperature of the glass. When the plastic is in the above-described viscous state, the plastic binds with the glass particles when the two are mixed. The temperature to which the glass and/or plastic are heated is significantly less than the temperature required to melt the glass. Hence, in comparison with other processes for manufacturing materials from recycled glass the energy input is much reduced.

It is preferable that the step of mixing the glass and plastic materials takes place in a vessel and the mixture may be heated whilst in the vessel, for example by a heating element immersed in the mixture. In one embodiment the vessel itself is heated.

The plastic is added gradually to the heated glass or glass, heated or otherwise may be added gradually to plastic heated to the required temperature.

The process may include the step of heating the glass and plastic mixture for between 5 and 15 minutes. The duration of the heating phase depends on the volume of mixture and the nature of the heat source. Preferably, the duration of the heating step is between 5 and 10 minutes and still more preferably, the step of heating the glass and plastic mixture is for substantially 6 minutes.

The process may include the step of adding the mixture to a mould.

Preferably, pressure is applied to the mould. Advantageously, the pressure applied to the material is 5 N/mm² or greater. It has been found through experiment that the material can be produced with three distinctly different surface finishes, each having its own use.

Where the pressure exerted on the material is 9.6 N/mm² or greater, and preferably between 9.6 and 11 N/mm², the resulting surface is smooth, and no surface coating is required, although the surface may be painted for example.

Where the pressure exerted on the material is between 8 and 9.6 N/mm² the surface is pitted, but the edges of the pits are resilient. This surface is suitable for the application of surface finishes in thin layers, such as plaster or thin renders for example.

Where the pressure exerted on the material is between 5 and 8 N/mm² the surface is pitted more deeply than where the pressure exerted is between 8 and 9.6 N/mm² and the edges of the pits are liable to crumble, the lower the pressure in the range the deeper the pits and the more likely are the edges of the pits to crumble. Such material has utility where a thick surface finish is to be applied, such as a floor screed or a thick render on a wall. Subjecting the material to a pressure of 7 N/mm², has been found to produce a particularly useful material for the application of thicker surface finishes.

Advantageously, pressure is applied to the material for between 15 seconds and 60 seconds, and preferably around 30 seconds.

The process may include the step of heating the material in the mould. The exterior surface of the mould may be heated.

The process may include the further step of quenching the material post heating thereof. Advantageously, the material is quenched after removal of the pressure from the mould. Preferably, the material is quenched after passage of an interval of time post removal of pressure from the mould. The time interval may be thirty seconds.

The mixture preferably comprises glass in the range of 65% to 85%, and plastic in the range of 35% to 15% (by weight).

In a preferred embodiment, the mixture comprises substantially 70% glass and substantially 30% plastic.

The glass may comprise recycled glass cullet. The glass is advantageously of a particle size not greater than 6 mm.

The particulate glass may be comprises of crushed glass comprising particulate glass having particles of different sizes up to a maximum size, for example 6 mm. Such material is formed by crushing glass, and passing the crushed glass over a screen having openings of a certain size. Any particles smaller than the size of the openings passes through, whilst any particles bigger than the openings do not.

The plastic is preferably polyethylene, nylon or abs, any of which may be recycled.

The block may comprise at least one cavity.

Advantageously, the block comprises male and female connectors.

In a preferred embodiment, the block is arranged to cooperate with an adjacent block by a dry interlock.

Whilst the material of the invention is not limited in its utility to the building trade, it does have particular use there. The material is strong, water proof or water resistant and may be manufactured from recycled materials with much less energy input than other known processes.

### BRIEF DESCRIPTION OF THE DRAWINGS

In the drawings, which illustrate the preferred embodiments of the invention by way of example:

FIG. 1a shows a perspective view of one embodiment of a block manufactured by the process of the invention;

FIG. 1b shows a perspective view of one embodiment of a block manufactured by the process of the invention;

FIG. 1c shows a perspective view of one embodiment of a block manufactured by the process of the invention;

FIG. 2 is a schematic representation of a material according to one embodiment of the invention.

### DETAILED DESCRIPTION OF THE PREFERRED EMBODIMENTS

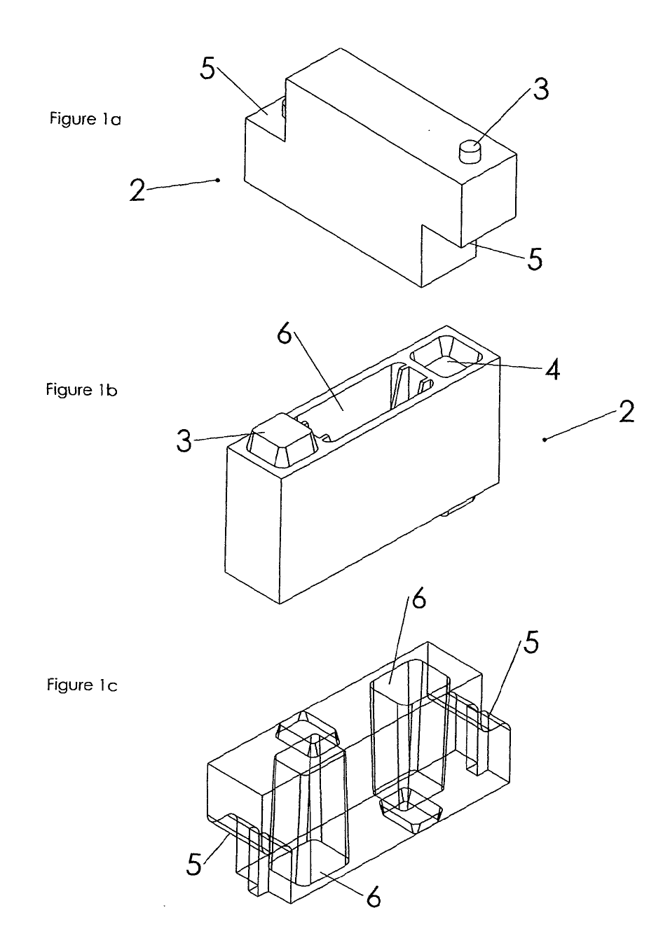

As illustrated in FIG. 1, a block 1 is manufactured by pre-heating glass to around 230° C. to 250° C., mixing the pre-heated glass with plastic, such as polyethylene, at room temperature by adding the plastic gradually into the mixture.

The plastic absorbs heat from the glass and the mixture is then heated before adding it to a mould. For the production of approximately 250 g of building material (corresponding the mass of a block), the glass/plastic mixture is heated for around 6 minutes before adding it to a mould. Following heating of this mixture, either a hot or cold mould is filled with the hot-mixed materials and pressed with a clamp.

The pressing step can be carried out manually by applying pressure to the mould to lock the said mould. In the example the mould comprised a screw thread in each corner and a pressure of 80N was applied to each corner of the mould.

It has been found that by applying a pressure of between 9.6 and 11 Newtons/mm² (which corresponds to the 80N applied to each corner of the mould in the above described example), the particles are maintained in an ideal structure during curing. This results in a material having a smooth surface. The pressure exerted on the surface of the material during curing stops the material expanding so very few air pockets develop in the material.

If the pressure is reduced to below 9.6N/mm², rather than the finish being smooth, the surface is pitted. This pitting is due to the development of air pockets in the material during curing. The lower the pressure the greater the pitting and the more open the surface.

In addition to having different surface properties, the materials subjected to different pressures during curing have different mechanical properties. For example, the material formed under a pressure of between 9.6 and 11 N/mm² can be drilled and a screw thread formed therein with a tap. However, the material is too hard to cut with a hack saw. A diamond saw would be required. Conversely, where the material is formed under a lower surface pressure, the material may be cut with a hack saw, and may be drilled. However, whilst a bore can be drilled in the material, a useful thread cannot be formed therein. The material is not sufficiently hard.

The pressure range for the above-mentioned lower pressure is between 5 and 9.6 N/mm². In fact, materials having two distinct surface properties can be formed by applying pressure in a range 5 to 8 N/mm² or 8 to 9.6 N/mm², as described above in the section entitled, “Summary of Invention”.

As an optional final step to achieve a smooth or shiny surface on the block, the outside surface of the mould can be heated with a torch

During the process of manufacture, the temperature is not raised to a level that melts the glass. However, the temperature of the preheated glass melts the plastic. This saves large amounts of energy in the manufacture of the building material. The level of energy consumed during the production of the block is very low because production temperature is 250 C or below and heat is applied for a short period. The length of time for which heat must be applied depends on the volume of material.

The block comprises 100% recycled materials. It includes waste materials including recycled glass (around 70%) and plastic such as recycled PET (around 30%). The recycled glass may be recycled glass cullet which may be supplied crushed, the particle size ranging from 6 mm down to dust. This recycled glass material is then added to a combination of plastic materials to form the building block.

The pieces of plastic are preferably of 2-10 mm in size, although some pieces may be larger and some may be smaller.

The glass particles may be coated with calcium carbonate. The calcium carbonate coating is preferably in the range 0.02 micron to 0.06 micron and advantageously 0.04 micron. By so coating the glass particles the glass particles become nacre. Coating the glass particles with calcium carbonate increases the insulation value of the resulting building material significantly. For example, whereas a 12.5 mm thick wall board formed from the building material of the invention where the glass is not coated with calcium carbonate had a U value of 0.054 W/m² k, the U value of a 12 mm thick wall board formed of the building material of the invention where the glass is coated with calcium carbonate as described above was 0.017 W/m²K.

The proportion of the glass in the block is in the range of 65% to 90% by weight. Where the proportion of glass falls below 65% the material is insufficiently stiff to function as a building material. Where the proportion of glass increases above 90% the material is too brittle to function as a building material.

A higher percentage of plastic gives better bonds between particles, blocks with lower weight, and better water resistance. A higher percentage of glass in the block gives better fire resistance and makes the mixing process easier. However, when the material includes more than 90% glass, the block loses its desirable properties.

Higher pressure applied to the material during manufacture gives better bonds between the glass and polyethylene particles. This in turn may allow lower temperatures to be applied during the mixing step of manufacture. Higher pressure results in better water resistance and a stronger material. The pressing force is an essential factor in determining the mechanical properties of the block, for example the insulation properties, water resistance, weigh to volume ration, strength in compression, appearance, etc.

As illustrated in FIGS. 1a to 1c, the building material 1 is formed into a block 2 having a male part 3 and a female part 4 which co-operate to form a dry interlock, without the need for mortar/cement. In the embodiment shown in FIGS. 1a and 1c, the blocks include stepped edges 5 which cooperate with adjacent blocks.

FIGS. 1b and 1c show blocks 2 that include a cavity 6 which makes them lighter than solid blocks, gives better insulation properties and enables them to formed using less material.

The blocks 2 are similar to conventional construction blocks or bricks.

Table 1 lists the properties of a block of dimensions 4 mm×10 mm×90 mm formed from the building material.

| | |
|---|---|
| Elastic Modulus | E = 1067 [N/mm2] |
| Shear Modulus | G = 395.2 [N/mm2] |
| Poissons Ratio | V = 0.35 |
| Tensile strength | 1.52 [N/mm2] |
| Compressive Strength | . . . = 9.56 [N/mm2] |
| Thermal Conductivity | K = 0.596 [W/mK] |
| Specific Heat | C = 1031.48 J/KgK] |
| Density | D = 2419.5 [Kr/m3] |

In a preferred embodiment a building block formed from the building material is of dimensions 450 mm×225 mm×112.5 mm.

The building block has a number of advantages over existing building materials. It is much less expensive and requires lower skill level of workmen and fewer man hours to install. The block is also a dry mix fit and does not use mortar. However, if mortar is desirable, it may be used.

The surface of a wall formed of blocks 2 can be rendered or painted and can be treated in the same way as a wall constructed of conventional materials. For example, it may be drilled and objects may be fastened to it.

Many different products may be formed from the building material of the invention, for example: building blocks, roof tiles, work surfaces, memorial caskets, head stones and bases, scaffolding boards and wall boards.

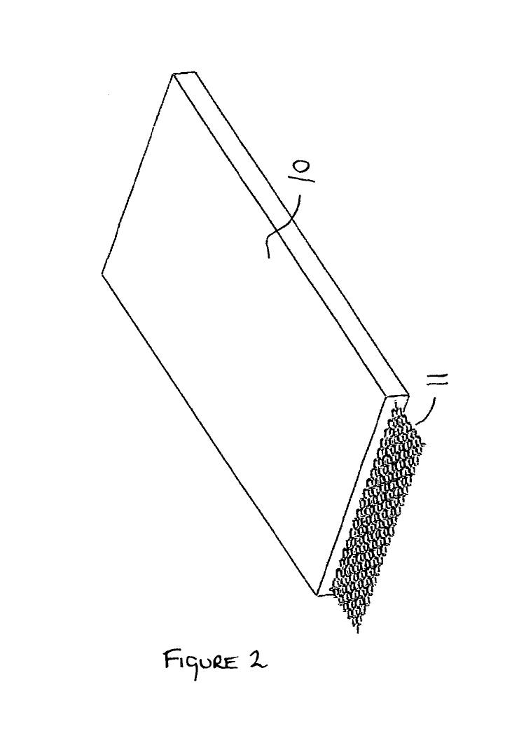

In the case of a wall board having a length of 8 feet, and width of 4 feet and a thickness of 12.5 mm and weighing 40 kgs, the heating time required will be between 10 and 15 minutes. The more material present the greater the heating time.

Where it is desirable to form an object of much greater thickness, such as memorial headstone, it may be desirable to increase the strength of the material. This may be done during manufacture of the material, by forming the material about a mesh or expanded sheet material (which may or may not be metal) after mixing of the building material but prior to curing. Such materials may well be able to have a thickness of 100 mm. Such a material is illustrated in FIG. 2, where a board 10 has been formed with a reinforcing mesh 11 therein.

It is possible to cut the block using a pruning saw (it does not require the use of specialist tools or a hammer as in common brick), which reduces noise during installation.

The production process for forming the brick is a simple process that does not require the same extent of capital equipment as is necessary for the production of masonry.

In one embodiment, the building material may be fire retardant. This may be achieved by coating the glass particles, or the calcium carbonate coated glass particles with boron. Such a coating may be between 0.02 and 0.08 micron.

1. A process for manufacturing a material including glass in particulate form and plastic, the process comprising the steps of:
i. Heating the plastic to a threshold temperature sufficient to change the state of the plastic from a solid to a viscous liquid;
ii. Mixing together the glass and plastic to form a mixture;
iii. Pressing the mixture into a desired shape;
iv. Curing the pressed mixture.

2. A process according to claim 1, wherein the threshold temperature is between 230 C and 250 C.

3. A process according to claim 1, wherein the method comprises one of the following steps:
heating the glass heated to the threshold temperature and mixing the heated glass with plastic at room temperature;
heating the plastic to the threshold temperature and mixing the heated plastic with glass at room temperature; and
heating the plastic to the threshold temperature and mixing the heated plastic with glass heated above room temperature up to the threshold temperature.

4. A process according to claim 1, wherein one of the plastic and the glass is added gradually to the other as mixing proceeds.

5. A process according to claim 1, comprising the further step of heating the glass and plastic mixture to maintain the temperature of the mixture at the threshold temperature.

6. A process according to claim 1, wherein during the mixing step the mixture is maintained at the threshold temperature by a heating means associated with the mixing vessel.

7. A process according to claim 1, wherein the step of exerting pressure on the mixture takes place in one of a press a mould or a die.

8. A process according to claim 7, wherein pressure is exerted on the material is in the range of 5-11 Newtons/mm².

9. A process according to claim 8, wherein the pressure exerted on the material is in the range of 5 to 8 Newtons/mm².

10. A process according to claim 8, wherein the pressure exerted on the material is in the range 8 to 9.6 Newtons/mm².

11. A process according to claim 8, wherein the pressure exerted on the material is in the range 9.6 to 11 Newtons/mm².

12. A process according to claim 7, wherein the pressure is exerted on the material for a period of between 15 and 60 seconds.

13. A process according to claim 12, wherein the pressure is exerted on the material for a period of approximately 30 seconds.

14. A process according to claim 7, comprising the step of heating the mixture, the computer including one of a press, a mould and a die.

15. A process according to claim 1, wherein the mixture comprises glass in the range of 65% to 90% and plastic in the range 35% to 15% by weight.

16. A process according to claim 15, wherein the mixture comprises substantially 70% glass and substantially 30% plastic.

17. A process according to claim 1, wherein the glass comprises recycled glass cullet.

18. A process according to claim 1, wherein the glass particles are in the range of 6 mm down to dust.

19. A process according to claim 1, including the step of coating the glass particles are coated in calcium carbonate.

20. A process according to claim 19, including the step of coating the glass particles in calcium carbonate to a thickness of 0.04 micron.

21. A process according to claim 1, wherein the plastic is polyethylene.

22. A process according to claim 1, including the further step of quenching the material post heating.

23. A process according to claim 1, including the step of laying a mesh substrate into the mixture prior to pressing thereof.

24. (canceled)

25. (canceled)

26. (canceled)

27. (canceled)
